(19) United States
(12) Patent Application Publication
(10) Pub. No.: US 2025/0262600 A1
(43) Pub. Date: Aug. 21, 2025

(54) GAS SEPARATION MEMBRANES

(71) Applicant: KATHOLIEKE UNIVERSITEIT LEUVEN, Leuven (BE)

(72) Inventors: Xiaoyu TAN, Hengdong (CN); Michiel DUSSELIER, Pellenberg (BE); Quanli KE, Hangzhou (CN); Sven ROBIJNS, Attenhoven (BG); Raymond THÜR, Kessel-Lo (BE); Ivo VANKELECOM, Oud-Heverlee (BE)

(21) Appl. No.: 18/859,381

(22) PCT Filed: Apr. 27, 2023
(86) PCT No.: PCT/EP2023/061160

§ 371 Date: Oct. 23, 2024

(30) Foreign Application Priority Data
Apr. 27, 2022 (EP) 22170367.1
Apr. 28, 2022 (EP) 22170463.8

(51) Int. Cl. B01D 69/14; B01D 53/22; B01D 67/00; B01D 71/02; B01D 71/64

(52) U.S. Cl. CPC B01D 69/148; B01D 53/228; B01D 67/0011; B01D 67/0083; B01D 67/0095; B01D 71/0281; B01D 71/64

(57) ABSTRACT

The invention relates to mixed matrix membranes (MMM) for the filtration and separation of gasses, the membrane comprising a glassy-polymer matrix with at least 20 or 30% w/w (zeolite/polymer) o characterised in that the zeolite polymer matrix lacks interfacial voids or voids are less than 50 nm, less than 20 nm or less than 10 nm measured at its longest dimension.

### FIELD OF THE INVENTION

The invention relates to membranes comprising zeolites and their use in gas or liquid separation.

### BACKGROUND OF THE INVENTION

Membrane technology has matured over the past 30 years to an established commercial technology for CO₂ separations, finding applications in natural gas sweetening and syngas treatment. In addition, purification of biogas, a “net zero CO₂,” energy vector, and carbon capture from flue gases also have the potential to become important applications for membranes in the near future. Although more conventional technologies, such as amine absorption, cryogenic separation and adsorption, definitely have specific advantages, membrane technology can offer a more sustainable alternative, owing to its low energy consumption, low environmental impact and modular design, allowing to retrofit membrane modules in already existing plants. Whereas the polymers that are used to make commercial CO₂-selective membranes are cheap and well-processable, they suffer from an intrinsic permeability/selectivity trade-off, making it extremely challenging to obtain membranes with combined high permeability and sufficient selectivity. On the other hand, inorganic membranes prepared from zeolites or from crystalline microporous hybrid materials like metal-organic frameworks (MOFs), typically display better performances but have poor mechanical properties, are expensive and face difficulties in processability and scalability. Development of new membrane materials for advanced separations is thus still required to render gas separation processes more sustainable.

Mixed-matrix membranes (MMMs) are hybrid membranes, consisting of fillers embedded in a polymeric matrix. These membranes combine the advantages of processability, flexibility and low cost of polymers with the filler's superior gas separation properties. Many porous materials have been investigated as fillers for MMMs, including zeolites, MOFs, carbon molecular sieves (CMSs), covalent organic frameworks (COFs), graphene and carbon nanotubes (CNTs). Zeolites are of particular interest for MMM development as they have well-defined, rigid pores combined with outstanding thermal, chemical and mechanical stability. Despite the great theoretical potential of zeolites in MMMs, a major obstacle is encountered in the polymer-zeolite compatibility. Since the intrinsically low selectivity and high permeability of rubbery polymers (e.g. polydimethylsiloxane (PDMS)) neutralizes the benefits of the zeolite, rigid glassy polymers are key to develop high-performance zeolite-filled MMMs. However, the notoriously poor interfacial adhesion between the inorganic zeolite and the rigid, glassy polymer typically results in non-selective interfacial voids. Consequently, obtaining high zeolite loadings (>50 wt. %) while guaranteeing a defect-free polymer-zeolite interface in combination with selecting a highly selective zeolite and a glassy polymer matrix can be considered as the main path towards successful high-performance zeolite-filled MMMs for a variety of the most critical modern gas separation challenges. Flue gas applications for instance should treat huge feed flows at low pressures, hence requiring highly permeable membranes, while the multiple stages that are currently required in methane upgrading could benefit from at least equally permeable but more selective membranes.

### SUMMARY OF THE INVENTION

Herein, as an embodiment of the invention, a platelet-shaped 8-membered-ring AEI-type zeolite (SSZ-39), possessing a long-range ordered 3D connected micropore system with a gas-selective window and excellent CO₂ adsorption, is incorporated in a Matrimid 5218 polymer matrix.

Thanks to the combination of a carefully optimized MMM synthesis procedure and the unique shape and sorption behaviour of zeolites, the classical problem of poor zeolite-polymer adhesion is circumvented and ultra-high zeolite loadings can be realized leading to unprecedented CO₂ separation performances, surpassing all previously reported performances of MMMs, and even many of the pure zeolite or MOF-membranes.

As an example, an ultra-high performance zeolite-filled, polyimide-based membrane for CO₂ removal was developed. This Na-SSZ-39/Matrimid MMM shows the best CO₂ removal performance so far from both N₂ and CH₄, which is not only higher than any existing MMM, but even higher than pure zeolite membranes. By solving the compatibility issue between the zeolite filler and the glassy Matrimid matrix, a defect-free zeolite/polyimide MMM with over 50 wt. % zeolite loading was prepared. A novel platelet-shaped Na-SSZ-39 zeolite was developed as filler for this membrane. Its excellent CO₂-philicity, outstanding CO₂ uptake capacity, desirable competitive gas adsorption behaviour and accurate size-exclusion for CH₄ promotes stunning gas separation of membrane. Moreover, thanks to the platelet-shape of the Na-SSZ-39 zeolite filler, a unique membrane morphology was obtained, which ensured a quasi-continuous permeation pathway for CO₂ which enhanced the performance of the membrane drastically. The present invention not only relates ultra-high-performance CO₂ removal membranes, but also exhibits a feasible methods to prepare a defect-free zeolite-filled membrane with a commercially available glassy polymer. It extends the applications of zeolites in the membrane field, and opens the door to make processable, robust, more scalable and economical high-performance zeolite-filled membranes, which is especially beneficial for those zeolites that are rather difficult to be transformed into defect-free thin-films. These membranes and their preparation techniques grant significant economic as well as environmental benefits for the global carbon-neutral future.

Herein, mixed-matrix membranes (MMMs) are investigated to render energy-intensive separations more efficiently by combining the selectivity and permeability performance, robustness, and nonaging properties of the filler with the easy processing, handling, and scaling up of the polymer. As an embodiment, a polyimide was filled with ultrahigh loadings of a high-aspect ratio, CO₂-philic Na-SSZ-39 zeolite to obtain a three-dimensional channel system that precisely separates gas molecules. By designing both zeolite and MMM synthesis, a flexible and aging-resistant (more than 1 year) membrane is obtained. The combination of a CO₂—CH⁴ mixed-gas selectivity of ˜423 and a CO₂ permeability of ˜8300 Barrer outperformed all existing polymer-based membranes and even most zeolite-only membranes.

The inventions is further summarised in the following statements:

1. A mixed matrix membrane (MMM) for the filtration and separation of fluids, obtainable by the method according to any one of statements 14 to 27, wherein the membrane comprises a glassy-polymer matrix with at least 20% w/w zeolite, and wherein the zeolite polymer matrix lacks interfacial voids or wherein voids are less than 20 nm measured at its longest dimension. These MMM can be equally used for the filtration and separation of fluid, or more general for molecular separations.
2. The MMM according to statement 1, wherein the membrane comprises a glassy-polymer matrix with at least 30, 40, or 50% w/w zeolite.
3. The MMM according to statement 1 or 2, wherein the zeolite is a platelet, cubic, cuboid, spherical or octahedron shaped zeolite.
4. The MMM according to any one of statements 1 to 3, wherein the zeolite is platelet shaped and has a concentration in the membrane of least 20% w/w, of least 30% w/w, of least 40% w/w, or of least 50% w/w.
5. The MMM according to any one of statements 1 to 4, wherein the membrane has a concentration of at least 40% w/w zeolite, and has a CO2 permeability of at least 4000 Barrer.
6. The MMM according to any one of statements 1 to 5, wherein the membrane has a concentration of at least 20% w/w zeolite/polymer, and has a CO2/CH4 selectivity >100.
7. The MMM according to any one of statements 1 to 5, wherein the membrane has a concentration of at least 40% w/w zeolite, and has a CO2/CH4 selectivity >400.
8. The MMM according to any one of statements 1 to 7, wherein the zeolite is platelet shaped.
9. The MMM according to any one of statements 1 to 8, wherein the zeolite is an 8 or 12 membered ring.
10. The MMM according to any one of statements 1 to 9, wherein the zeolite is of the AEI type.
11. The MMM according to any one of statements 1 to 10, wherein the membrane is flexible and has a flexural modulus of between 2 up to 9 Gpa.
12. The MMM according to any one of statements 1 to 11, wherein the membrane is flexible and has a flexural modulus of between 3.5 up to 9 Mpa.
13. The MMM according to any one of statements 1 to 12, wherein the polymer is a polyimide.
14. A method for preparing a mixed matrix membrane comprising the step of:
a) preparing a glassy polymer and zeolite mixture in a solvent, wherein the solvent comprises at least 5% w/v polymer, and comprises at least 20, 30, 40 or 50% w/w zeolite,
b) casting the mixture obtained in step a),
c) drying the cast mixture obtained in step b) to obtain a membrane, wherein the drying is performed at a rate whereby between 85 and 95 wt. % of the solvent is removed over a period of between 15 minutes and 24 hours,
d) heating the dried membrane obtained in step c) at a temperature below the glass transition temperature of the polymer, wherein the heating is maintained for a period of between 5 min and 24 hours and/or is performed at a temperature of between 3° and 300° C., with the proviso that the temperature is below the transition temperature of the polymer.

In the preparation of these membrane no crosslinking of the membranes occurs.

Furthermore, as shown in the examples drying step c can be performed with applying a vacuum.

15. The method according to statement 14, wherein the solution of polymer and the dispersion of zeolite are prepared separately and subsequently mixed.
16. The method according to statement 14 or 15, wherein the drying in step c) is performed at a rate whereby between 85 and 95 wt. % of the solvent is removed over a period of between 5 minutes and 24 hours.
17. The method according to statement 14 or 15, wherein the drying in step c) is performed at a rate whereby between 85 and 95 wt. % of the solvent is removed over a period of between 3 and 24 hours.
18. The method according to any one of statements 14 to 17, wherein in step d, the membrane is heated as a temperature between 30° C. and the glass transition temperature of the polymer.
19. The method according to any one of statements 14 to 17, wherein in step d, the membrane is heated as a temperature of between 120 or 150° C. and the glass transition temperature of the polymer.
20. The method according to any one of statements 14 to 19, wherein the heating in step d) is maintained for a period between 4 hours and 24 hours.
21. The method according to any one of statements 14 to 19, wherein the heating in step d) is maintained for a period between 8 hours and 24 hours.
22. The method according to any one of statements 14 to 19, wherein the heating in step d) is maintained for a period between 8 hours and 24 hours and/or wherein step d) is performed at a temperature of between 150° C. and 300° C.
23. The method according to any one of statements 14 to 22, followed by a step wherein the absence of voids is determined.
24. The method according to statement 23, wherein the absence of voids is determined by microscopy.
25. The method according to statement 23, wherein the absence of voids is determined by measuring the flow rate of a gas over the membrane.
26. The method according to any one of statements 14 to 25, wherein the zeolite is platelet shaped.
27. The method according to any one of statements 14 to 26, wherein the zeolite is of the AEI type.
28. The method according to any one of statements 14 to 27, wherein the polymer is polyimide.

A mixed matrix membrane (MMM) for the filtration and separation of fluids, obtainable by the method according to any one of statements 14 to 27

### DETAILED DESCRIPTION

### Figure Legends

FIG. 1 A. SEM picture of a platelet-shaped Na-SSZ-39 zeolite; B. SEM cross-section picture of Na-SSZ-39 MMM without thermal annealing (20 wt. % zeolite loading); C. SEM cross-section picture of Na-SSZ-39 MMM after the 260° C. thermal annealing (20 wt. % zeolite loading); D. SEM cross-section picture of Na-SSZ-39 MMM with the 260° C. thermal annealing (40 wt. % zeolite loading); E. SEM cross-section picture of the 30 wt. % Na-SSZ-39 MMM after oxidative treatment at 800° C.; F. SEM top-view of membranes with 0 wt. % to 50 wt. % zeolite loading; G. SEM bottom-view of membranes with 0 wt. % to 50 wt. % zeolite loading.

FIG. 2 The gas separation performance of the Na-SSZ-39 MMM membranes: A. the selectivity difference between cuboid Na-SSZ-39 MMM and platelet Na-SSZ-39 MMM; B and C. the temperature and pressure dependence of CO₂/CH₄ selectivity and CO₂ permeability (from bottom to top: 0 wt. %, 10 wt. %, 20 wt. %, 30 wt. %, 40 wt. %, 50 wt. % zeolite loading); D and E. the zeolite-based MMMs from literature [squares] plotted against the CO₂/N₂ and CO₂/CH₄ Robeson plot of 2008, the stars represent data from MMMs with platelet-shaped Na-SSZ-39 fillers (from left to right, 10 wt. %, 20 wt. %, 30 wt. %, 40 wt. %, 50 wt. %, 55 wt. % zeolite loading); F. the pure zeolite membranes from literature [squares] compared with the 50 wt. % Na-SSZ-39 MMM in the 2008 CO₂/CH₄ Robeson plot.

FIG. 3.a CO₂, CH₄, N₂ adsorption isotherms of Na-SSZ-39 and SSZ-39 zeolites at 10° C. based on the high-pressure physisorption experiments. The results presents high CO₂-philicity and gas uptake capacity.

FIG. 3.b Comparison of the experimental and GCMC simulation results of the CO₂, CH₄, N₂ unary gas adsorption isotherms of Na-SSZ-39 zeolite at 25° C.

FIG. 3.c Comparison of the CO₂ and CH₄ unary gas adsorption isotherms and the CO₂/CH₄ (50 vol. %/50 vol. %) binary gas adsorption isotherms of Na-SSZ-39 zeolite at 25° C. (by GCMC simulation). The CO₂ adsorption prevents the CH₄ adsorption, which indicates the strong competitive gas adsorption behaviours that enhanced the mixture gas separation performance.

FIG. 3.d Comparison of the CO₂ and N₂ unary gas adsorption isotherms and the CO₂/N₂ (50 vol. %/50 vol. %) binary gas adsorption isotherms of Na-SSZ-39 zeolite at 25° C. (by GCMC simulation). The CO₂ adsorption prevents the N₂ adsorption, which indicates the strong competitive gas adsorption behaviours that enhanced the mixture gas separation performance.

FIG. 3.e 3D CO₂ adsorption density plot of Na-SSZ-39, CO₂ adsorption iso-surface at 0.1 bar (sections indicated by ellipsoid) and 1 bar (total gray cloud).

FIG. 3.f Illustration of random, non-aligned packing of zeolite platelets in the polymer matrix from 10 wt. % to 50 wt. % zeolite loading.

FIG. 3.g 3D illustration of random, non-aligned packing of zeolite platelets inside the polymer matrix.

FIG. 4 Cross-section SEM picture of Na-SSZ-39 MMM with 260° C. 24 hours thermal annealing program, which reveals to the defect-free zeolite/polymer interface and no void observed. This picture indicates a good zeolite and polymer compatibility (with no leakage of the membrane) and promise high membrane performance.

FIG. 5 Top-view SEM picture of Na-SSZ-39 MMM with 260° C. 24 hours thermal annealing program, which reveals to the defect-free zeolite/polymer interface and no void observed.

FIG. 6 SEM picture of the cross-section of Na-SSZ-39 MMM with 300° C. 24 hours thermal annealing. De-attaching between zeolite and matrimid matrix occurring.

FIG. 7 Cross-section SEM picture of Na-SSZ-39 MMM with 350° C. 24 hours thermal annealing. Further de-attaching between zeolite and matrimid matrix.

FIG. 8 The XRD results of thermal annealed (260° C. program) Na-SSZ-39 MMMs from 0 wt. % (pure matrimid) to 55 wt. % zeolite loading. The membrane samples show strong characterization XRD signals of the AEI zeolite, which indicates very high zeolite loading of the membranes.

FIG. 9 The transmittance FTIR patterns of the Na-SSZ-39 zeolite, pristine matrimid membrane, and thermal annealed (with 260° C. program) 0 wt. % (pure matrimid membrane), 10 wt. %, 20 wt. %, 30 wt. %, 40 wt. %, 50 wt. %, 55 wt. % Na-SSZ-39 MMMs. Except for the characterization peaks of zeolite, there is no new peak observed after zeolite loading and thermal treatment, which indicates no chemical reaction occurs in the zeolite/polymer interface.

FIG. 10 Comparison of unary and equal mole binary CO₂/N₂ and CO₂/CH₄ gas solubility selectivity of Na-SSZ-39 zeolite (under 25° C.) based on GCMC simulation. The CO₂/N₂ and CO₂/CH₄ solubility selectivity in binary gas case are higher than the unary gas case, which indicates the strong competitive gas adsorption behaviours that enhanced the mixture gas separation performance.

FIG. 11 Carbon dioxide, nitrogen and methane adsorption isotherms for thermal annealed (260° C. program) pure matrimid membrane and 50 wt. % Na-SSZ-39 MMM at 25° C. The gas uptake performances get significant enhancement with the zeolite loading.

FIG. 12 Carbon dioxide adsorption isotherms for Na-SSZ-39, SSZ-39 and Na-SSZ-39 MMM for a temperature range of 10-50° C. Dotted lines correspond to the Toth isotherm model. High CO₂ adsorption capacity and high CO₂-philicity was presented, and the Na-SSZ-39 shows enhanced CO₂ gas uptake performance and increased CO₂ affinity.

FIG. 13 Methane adsorption isotherms for Na-SSZ-39, SSZ-39 and Na-SSZ-39 MMM for a temperature range of 10-50° C. Dotted lines correspond to the Toth isotherm model. The CH₄ adsorption capacity and CH₄ affinity is significantly lower than CO₂ case.

FIG. 14 Nitrogen adsorption isotherms for Na-SSZ-39, SSZ-39 and Na-SSZ-39 MMM for a temperature range of 10-50° C. Dotted lines correspond to the Toth isotherm model. The N₂ adsorption capacity and N₂ affinity is significantly lower than CO₂ case.

FIG. 15 The extension and load force diagram of the 3-points bending testing for 4 membrane samples: pure Matrimid membrane (without thermal treatment); 260° C. thermal annealed pure Matrimid membrane; 50 wt. % zeolite MMM (without thermal treatment); 260° C. thermal annealed 50 wt. % zeolite MMM. All of membrane coupons show good flexibility during the test, and all of the membrane samples returned to their original shape after removing the loading. Although both of the zeolite loading and thermal annealing treatment reduced the flexibility of the membrane coupons, the annealed 50 wt. % MMM still presents high flexibility. And the zeolite MMMs with lower zeolite loading could possess higher flexibility than this membrane samples.

FIG. 16 DSC result of the 10 wt. % and 30 wt. % a Na-SSZ-39 MMM with 260° C. thermal annealing. The glass transition temperature (Tg) of the annealed Na-SSZ-39 MMMs increased from 320° C. to 330° C., pointing towards polymer chain rigidification at the polymer-zeolite interface, which indicates the wrapping of the zeolite by the polymer.

FIG. 17: Robeson plot for CO₂/CH₄ selectivity and permeability. Circles are values of prior art membranes. Stars refer to membranes of examples of the present invention.

FIG. 18: Gas separation performances of zeolite-filled MMMs prepared by the methods of the present invention:
(A) the performance of zeolite-filled MMMs from literature is shown in CO2-CH4 2008 Robeson plots, and the stars indicate the Na-CHA-10/Matrimid MMMs;
(B) the performance of zeolite-filled MMMs from literature is shown in CO2-N2 2008 Robeson plots, and the stars represent the Na-FAU-2/Matrimid MMMs;
(C) the performance of zeolite-filled MMMs from literature is shown in CO2-N2 2008 Robeson plots, and the star refers to the 50 wt. % Na-FAU-2/polysolfune MMM and hollow star points to the unfilled polysulfone membrane.

In panels A and B, the different stars point to different zeolite loading in the MMMs. From left to right, they are 10 wt. %, 20 wt. %, 30 wt. %, 40 wt. %, 50 wt. %, 60 wt. % zeolite.

The concentration of zeolites in the membranes can also be expressed as % w/w. Since the membranes only exist of zeolite and polymer. It refers to the amount zeolite in the sum of zeolite+polymer. Herein 20% w/w zeolite is e.g. a membrane of 10 gram with 2 gram zeolite and 8 gram polymer (2 gram zeolite/2 gram zeolite+8 gram membrane).

As can be derived from the examples of the present invention the polymers in the membranes of the present invention are not-crosslinked.

A glassy polymer is a type of polymer that exhibits a high stiffness, glass-like, amorphous solid state at room temperature. The glass transition temperature (Tg) of a glassy polymer is higher than the room temperature. This means, different from the rubbery polymer, the glassy polymer could maintain a glassy-state, random arrangement of its molecular chains at room temperature with high strength and stability. Examples of glassy polymers are polystyrene, polyimide, polysulfone, polyvinyl acetate, polylactic acid, polyvinyl chloride, polymethyl methacrylate, polysulfone, poly(ether sulfone), polycarbonate, polypropylene and polyethylene.

Mixed-matrix membranes (MMMs), which consist of fillers embedded in a polymeric matrix, combine the intrinsic advantages of a polymeric membrane with the filler's superior gas separation properties.

Zeolites are of particular interest for MMM development because they have well-defined, rigid pores and outstanding thermal and chemical stability. Because the intrinsically low selectivity and high permeability of rubbery polymers (such as polydimethylsiloxane) neutralize the benefits of the zeolite, rigid glassy polymers are used for the development of high-performance zeolite-filled MMMs. However, the poor adhesion between zeolites and glassy polymers typically results in nonselective interfacial voids. Consequently, obtaining high zeolite loadings (250 wt %) while guaranteeing a defect-free polymer-zeolite interface in combination with a highly selective zeolite and appropriate glassy polymer matrix is required to the creation of high-performance MMMs for a variety of the most critical separation challenges. As an example, a platelet-shaped, CO₂-philic, small-pore (eight-membered ring) AEI-type zeolite (SSZ-39), possessing a long-range ordered three-dimensional (3D)-channel system and gas-selective windows, was incorporated in a poly(3,3′-4,4′-benzophenone tetracarboxylic-dianhydride diaminophenylindane) (Matrimid 5218) polymer. The combination of zeolite and MMM syntheses, results in a high zeolite loading with a quasi-continuous zeolite phase across a self-standing membrane.

A first aspect of the invention relates to a mixed matrix membrane (MMM) for the filtration and separation of gasses, the membrane comprising a glassy-polymer matrix with at least 20 or 30% w/w (zeolite/(zeolite+polymer)).

Alternatively to filtration and separation of gasses, the membranes can be used for other types of molecular filtration.

The membranes can be further characterised in that the zeolite polymer matrix lacks interfacial voids or voids are less than 50 nm, less than 20 nm or less than 10 nm measured at its longest dimension.

In embodiments of these membranes, the zeolite has a platelet, cubic, cuboid, spherical or octahedron shaped zeolite.

Other examples of suitable and commercially available zeolites for use in the membranes of the present invention are cubic shaped CHA, spherical shaped LTA, octahedron shaped FAU.

Based on SEM pictures of the membranes present invention (with 10000-25000 magnification) of the top view, bottom view, and cross-section view of the membrane, no detectable (less than 20 nm) voids were observed. This is corroborated by the gas separation results with these membranes. Ultra-high selectivity membranes were obtained (>420 gas selectivity for CO₂/CH₄ mixed gas feedstream). Small leakages via voids in this case would cause a significant selectivity loss.

As an alternative to defining the properties of a membrane by permeability or selectivity, it is also possible to characterise a membrane with reference to a Robeson upperbound limit which describes a performance trade-off between permeability and selectivity. It is a limit beyond which no state-of-the-art membranes show performance for a given separation (e.g. CO₂/N₂ or CO₂/CH₄). The Robeson relation between the selectivity a and the permeability P (units in Barrer) can be expressed as:

α·Pⁿ=k

wherein n and k are coefficients. Since the selectivity and permeability of membranes are typically plotted on logarithmic scale the Robeson plot therein assumes a linear shape. The region above the Robeson plot can be expressed as:

α·Pⁿ>k

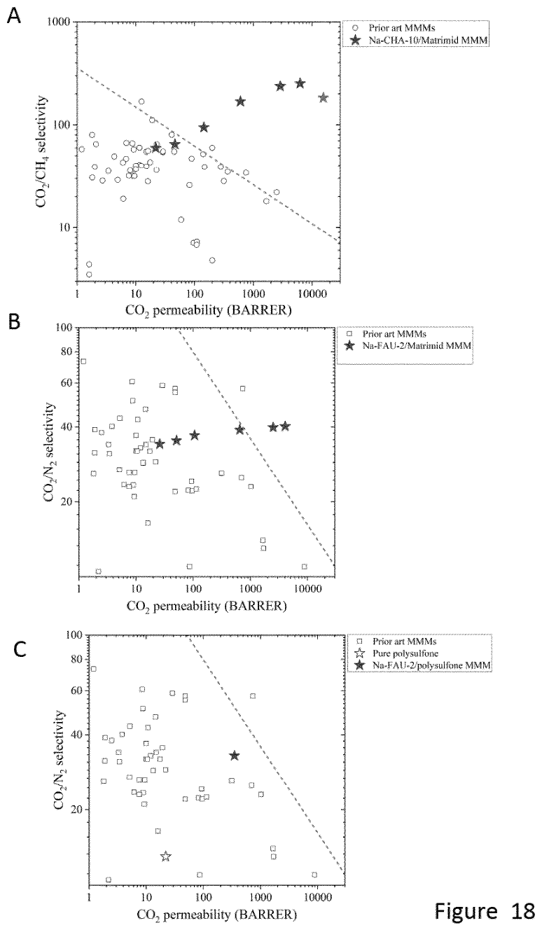

For the CO₂/CH₄ gas separation by prior art mixed matrix membranes the Robeson upper bound can be expressed as a·P^{0,41}=550. The current work Na-AEI mixed matrix membranes show values for a·P^{0,41} ranging from 660 to 20.000 and for zeolite concentrations between 20 and 55%, i.e. well above 550 (see FIG. 17).

For CO₂/N₂ separations by prior art mixed matrix membranes the Robeson upper bound can be expressed as a·P^{0,34}=250.

For CH₄/N₂ separations by prior art mixed matrix membranes the Robeson upper bound can be expressed as a·P^{0,239}=6,79. In this work we demonstrated a 65 wt % Na-CHA MMM with a·P^{0,239}-value well above 6,79 and up to a range of 50-60.

In embodiments of the first aspect of the invention, the zeolite is platelet shaped and has a concentration in the polymer of least 10% w/w, of least 15% w/w, of least 20% w/w, of least 25% w/w, of least 30% w/w, of least 40% w/w, or of least 50% w/w (zeolite/polymer).

Note that a concentration of 30% w/w platelet shaped zeolite corresponds to a volume of zeolite in the membrane of 25 v/v %.

In embodiments of the first aspect of the invention, the zeolite is cubic shaped and has a concentration in the polymer of least 30% w/w, of least 40% w/w, of least 50% w/w, of least 60% w/w (zeolite/polymer).

In embodiments of the first aspect of the invention, a membrane with a concentration of at least 30% w/w zeolite/polymer has a CO₂ permeability of at least 600 Barrer.

In embodiments of the first aspect of the invention, a membrane with a concentration of at least 40% w/w zeolite/polymer has a CO₂ permeability of at least 4000 Barrer.

In embodiments of the first aspect of the invention, a membrane with a concentration of at least 50% w/w zeolite/polymer has a CO₂ permeability of at least 10000 Barrer.

In embodiments of the first aspect of the invention, a membrane with a concentration of at least 20% w/w zeolite/polymer has a CO₂/CH₄ selectivity >100.

In embodiments of the first aspect of the invention, a membrane with a concentration of at least 30% w/w zeolite has a CO₂/CH₄ selectivity >300.

In embodiments of the first aspect of the invention, a membrane with a concentration of at least 40% w/w zeolite has a CO₂/CH₄ selectivity >400.

In embodiments of the first aspect of the invention, the zeolite is platelet shaped.

In embodiments of the first aspect of the invention, the zeolite is in a random non-aligned packing within the polymer.

In embodiments of the first aspect of the invention, the zeolite is an 8, 10 or 12 membered ring.

Other suitable zeolites for use in the membranes of the invention are e.g. zeolites such as RRO, RHO, FER and LTA In embodiments of the first aspect of the invention, the zeolite is of the AEI, CHA, LTA or FAU type.

Herein CHA are Cubic shape, LTA are spherical shape and FAU are Octahedron shape.

It is clear that the CHA, LTA and FAU are also able to be prepared as the defect-free zeolite MMMs for gas separations.

In embodiments of the first aspect of the invention, the zeolite is of the AEI type.

In embodiments of the first aspect of the invention, the AEI framework is free from outer-framework aluminium species.

In embodiments of the first aspect of the invention, the zeolite is a platelet shaped, 8-membered AEI type SSZ-39 zeolite.

Modification in the type of framework of a zeolite lead to a different pore size and has an effect on the type of gasses to be separated. Equally the type of counter cations affects the interaction with gas molecules and hence selectivity as well as pore size. Also the Si/Al mole ratio affects polarizability and pore size.

Nearly 10% of aluminium sites of SSZ-39 zeolite was occupied by Na+ and at least 90% of aluminium site of Na-SSZ-39 (the fully Na+ exchanged SSZ-39 zeolite) was occupied by Na+.

In embodiments of the first aspect of the invention, at least 40%, at least 60%, at least 80% at least 95%, at least 98% or at least 99% of the aluminium sites in the zeolite are occupied by sodium ions.

Adding aluminium sites, allows to tune the polarizability and the counter-ions of zeolite fillers, which will change the gas adsorption/diffusion properties and influence to the overall membrane performance.

The data of the present invention reveals that the gas separation performances of zeolite MMM dominantly rely on the Si/Al mole ratio of zeolite fillers.

In embodiments of the first aspect of the invention, platelet zeolites have a thickness of between 90 and 200 nm.

In embodiments of the first aspect of the invention, cubic or cubic, cuboid, spherical or octahedron shaped zeolites have a particle size of between 200 nm and 5 μm.

In embodiments of the first aspect of the invention, platelet zeolites have a size of between 1×1 μm or 1.25×1.25 μm and between 1.75×1.75 μm or 2×2 μm.

In embodiments of the first aspect of the invention, zeolites have a bulk density of between 15, 20, or 50 mg/cm³ up to 100, 200, 500 mg/cm³.

In embodiments of the first aspect of the invention, the membrane is flexible and has an flexural modulus between 3.5, 4 or 4.5, up to 6.0, 6.5, 7, 7.5, 8.0, 8.5 up to 9 Mpa.

In embodiments of the first aspect of the invention, wherein the polymer is polyimide.

Typically glassy polymers for use in the present invention have a lower gas permeability than zeolite filler. The polymer is compatible with the zeolite fillers, and can enclose the zeolite filler but not intrude into pores. The polymer does not decompose and does not shrink by more >10 vol %) during the thermal annealing.

A second aspect of the invention relates to a method for preparing a mixed matrix membrane comprising the step of:
a) dissolving a glassy polymer in a solvent,
b) preparing a zeolite dispersion [typically in the solvent of step a]
c) mixing the dissolved polymer of a) with the dispersion of b), in an amount that the mixture comprises at least 5% w/v polymer/solvent, and in that the amount of zeolite is at least 20, 30, 40 or 50% w/w zeolite/(zeolite+polymer),
d) casting the mixture obtained in step c),
e) drying the mixture to obtain a membrane
f) heating the membrane obtained in step e) at a temperature of between 120
or 150° C. and the glass transition temperature of the polymer

Typically an upper limit of 15-20 wt % polymer/solvent can be used in step c) Specific embodiments of the method uses a type of zeolite at concentration to obtain MMM as recited in the above aspect on MMM products.

As can be understood from the examples section, the method does not include or require a cross-linking of the polymer in the membrane.

In embodiments of the second aspect of the invention, the drying in step e) is performed at a rate whereby between 85 and 95 wt. % of the solvent is removed over a period of between 3 and 24 hours

In this method, the speed of solvent removal is monitored to prevent detachment of the rigidifying polymer of the zeolite.

In embodiments of the first aspect of the invention, the heating is maintained for a period between 8 hours and 24 hours.

In embodiments of these methods a funnel is used to create a confined space above the casting solution film to reduce the solvent removal speed.

For example Chloroform has a boiling point at 61.2° C., whereby a funnels is used to slow down the solvent evaporation speed.

In other embodiments a high boiling point (typically above 150° C.) solvent is used (e.g. Tamisolve, boiling point ˜240° C.) or a climate chamber with solvent vapour atmosphere to reduce the solvent evaporation speed.

In embodiments of the second aspect of the invention, is performed at a temperature of between 150° C. and 300° C.

In embodiments of the first aspect of the invention, step f is performed, at a temperature of between 180° C. and 280° C., or between 20° and 280° C., or between 24° and 280° C. or between 25° and 270° C.

In embodiments of the second aspect of the invention, the method further comprise the step of determining the gas permeability and selectivity of the prepared membranes and selecting membranes with a permeability which is at least 100% higher and a selectivity for CO₂/CH₄ which is at least 50% higher than the same membrane without zeolite which underwent the same heat treatment.

In embodiments of the second aspect of the invention, the zeolite is platelet shape.

In embodiments of the second aspect of the invention, the zeolite is an 8-membered ring.

In embodiments of the second aspect of the invention, wherein the zeolite is of the AEI type.

In embodiments of the second aspect of the invention, the polymer is polyimide.

In embodiments of the second aspect of the invention, the solvent is chloroform or a dipolar aprotic solvent.

A third aspect of the invention relates to a membrane obtainable by the method disclosed above as second aspect of the invention and its embodiments.

The gas-separation performance of the MMM of the present invention can be explained by a number of factors

Zeolites possess enormous diffusivity and solubility selectivities, thus promoting ultrahigh mixed-gas selectivity. In specific embodiments, noncentrosymmetric AEI-type frameworks allows preparation of high-aspect ratio platelets.

Further, a sudden jump in CO₂—CH₄ separation factor with increasing zeolite % loading is indicative of a percolation effect, whereby gas permeation through the membrane is predominantly going through the zeolite phase. The zeolites create a quasi-continuous zeolite phase across the membrane which allows for percolation of the gas molecules with minimal influence of the less permeable polymer phase. Zeolite platelets pile up from the bottom and appear at the top of membrane. A non-aligned, randomly oriented distribution leads to a selective gas permeation highway, allowing the membrane's performance. It was further found that platelet shaped zeolites result in a better selectivity and permeability than cuboid shaped zeolites.

In addition, the overall gas transport through the MMM is a net result of the properties of both zeolite and polymer, as well as of their mutual interactions, whereby it is important to obtain a defect-free zeolite-polymer interface. Although rubbery polymers, such as polydimethylsiloxane (PDMS), facilitate creation of a defect-free interface, their intrinsically low selectivity and high permeability neutralize the beneficial contribution of a zeolite embedded therein. The membrane preparation methods of the present invention prevents the occurrence of unselective voids at the zeolite-polymer interface, allowing for ultrahigh zeolite loadings of >50 wt % without chemical modification of zeolite or polymer nor use of additives.

An ultrahigh-performance zeolite-filled MMM for CO2 separations was developed that shows unprecedented CO₂ removal performance, not only greater than that of any existing polymeric membrane or MMM but even surpassing that of most zeolite-only membranes. By circumventing the traditional incompatibility between zeolite filler and glassy polymer matrix, a flexible, defect-free zeolite-polyimide MMM was prepared with ultrahigh (>50 wt %) zeolite loadings. Na-SSZ-39 zeolite was discovered to be a superior filler because of its outstanding CO₂-philicity, precise molecular-sieving windows, strong competitive sorption behaviour, and excellent stability, promoting strong, nonaging CO₂-separation performances. Because of the high-aspect ratio and 3D-channel system of the filler, a percolating gas permeation highway was created across the membrane, thus drastically enhancing the membrane's performance.

A scalable method was used to prepare defect-free zeolite-filled membranes with a commercially available glassy polymer, thus opening the door to developing well-processable, robust, and economical high-performance zeolite-filled MMMs for a variety of gas and liquid separations. It is especially beneficial for those zeolites that are difficult to be engineered into defect-free zeolite-only films.

### Example 1 Mixed-Matrix Membrane Preparation in Lab-Scale

Mixed-matrix membranes (MMMs) containing 10, 20, 30, 40, 50, 55 wt. % of zeolite were prepared. Firstly, 0.3 g of Matrimid was dissolved in 2.70 g chloroform to make a 10 wt. % homogeneous Matrimid solution. Next, an amount of the zeolite was added to 1.80 g chloroform to make a zeolite dispersion. The zeolite dispersion was stirred for 2 h and thoroughly sonicated for 1 h. For each zeolite dispersion, 3 g of 10 wt. % Matrimid solution was added. All zeolite/polymer solutions were stirred on a magnetic stirring plate for 8 h, and sonicated twice (1 hour per turn) in the beginning and the ending of the stirring process. The final mixture was cast into a Petri dish (d=7 cm) in a nitrogen bag. The polymer concentration was adjusted to be around 7 wt. % to obtain a viscous solution that can be cast but will not suffer much from zeolite precipitation during solvent evaporation. Evaporation of chloroform was slowed down by putting a glass funnel with small opening (diameter=3 mm, interior volume of the funnel z 30 cm³) over the Petri dish. The glass funnel generated a saturated chloroform vapor phase above the polymer solution layer, reducing the solvent evaporation speed. This led to slow solidification of the membrane film in approximately 1 h. The solidified membrane was kept in the nitrogen bag for 12 h, removed from the Petri dish and dried naturally for 10 h before thermal treatment.

The zeolite loading was calculated by using equation 1:

$$Zeolite loading ( wt \% ) = 100 \times ( \frac{{m}_{zeolite}}{{m}_{zeolite} + {m}_{polymer}} )$$

where m_{zeolite} and m_{polymer} are the weight of the zeolite and the polymer, respectively.

For the post thermal annealing process, dried membranes were placed between glass supports to prevent curling and were placed in a muffle oven. The muffle oven was heated to 180° C., 260° C. (below the glass transition temperature (Tg) of Matrimid), 300° C. (below but close to the Tg of Matrimid) and 350° C. (above the Tg of Matrimid). The heating protocol entailed heating at 1° C. min-1 from room temperature to the final annealing temperature with 30° C. increments. At each increment, the oven was kept isothermally for 2 hours. The membranes remained at the final temperature for 24 hours, and were removed after the oven cooled down to room temperature naturally as too fast quenching will result in voids between the polymer matrix and the filler due to the difference in the thermal expansion coefficients of the two materials. By allowing the MMMs to cool down naturally, a good adhesion between the polymer chains and the zeolite could be kept.

### Example 2 Zeolite Characterization

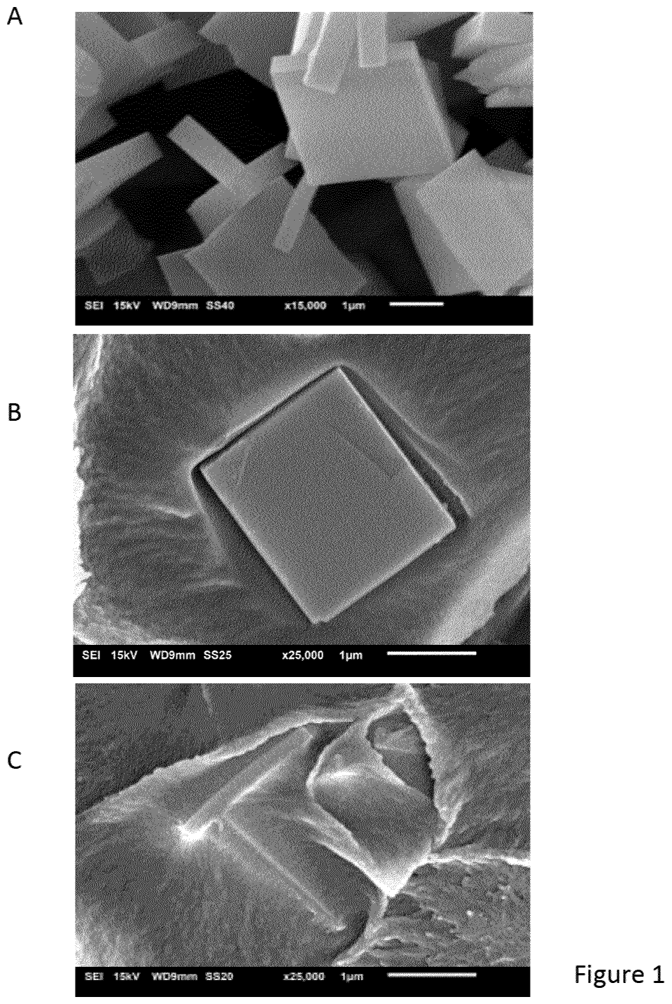

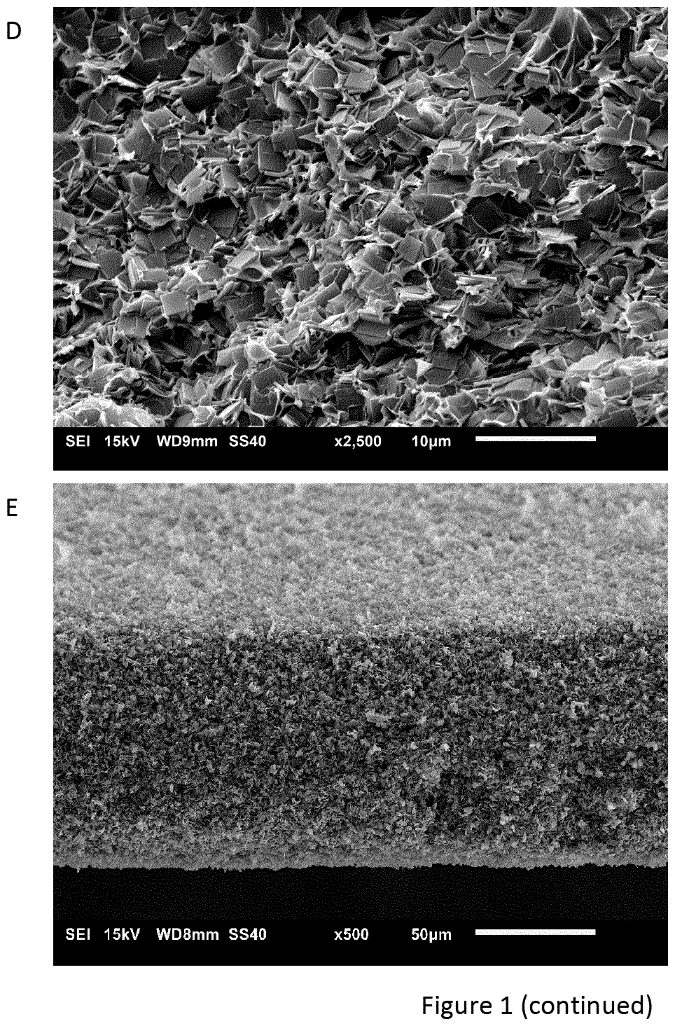

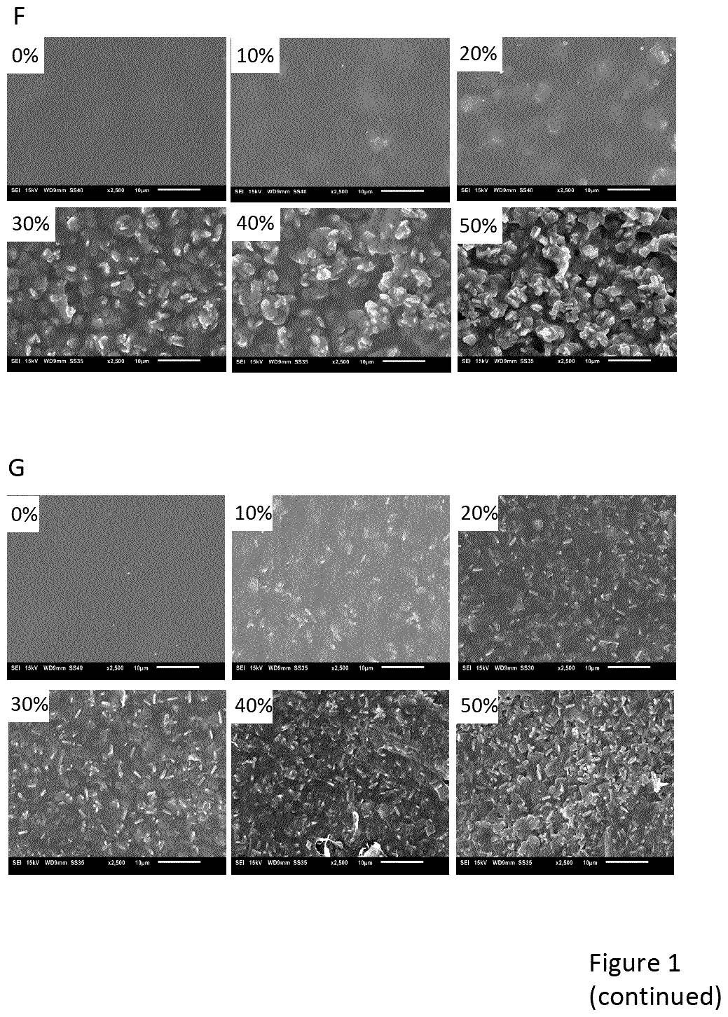

Powder X-ray diffraction (pXRD) of the Na-SSZ-39 zeolite confirmed a highly crystalline AEI framework, in good agreement with previous Na-SSZ-39 reports. N₂ adsorption experiments demonstrated that the synthesized Na-SSZ-39 possessed nearly 100% microporous content and a pore volume of 0.28-0.29 cm³/g, which is close to the theoretical maximum accessible volume of the AEI-type framework. According to literature, Na-SSZ-39 synthesis results in an AEI framework free of outer-framework aluminium species, which suggests a nearly perfect, 3D-connected channel system, allowing fast gas transport. SEM images showed platelet-shaped Na-SSZ-39 zeolites of ˜100 nm thickness and approximately 1.5×1.5 μm² in size (FIG. 1.a). As a result of the loose packing of the zeolite plates, a very low bulk density of 20 mg/cm³ was obtained.

CO₂, CH₄ and N₂ gas uptake and isosteric adsorption enthalpies (Qₛₜ) were determined for both SSZ-39 (SSZ-39, Na/Al ratio=0.12) and Na⁺-exchanged SSZ-39 (Na-SSZ-39, Na/Al ratio=0.93) zeolites. The adsorption isotherms of CO₂, CH₄ and N₂ at 10° C. to 50° C. over a pressure range of 0-8 bar are shown in FIG. 12, 13, 14. For both SSZ-39 and Na-SSZ-39, the gas uptake decreases in a logical order from CO₂>CH₄>N₂, attributed to the expected differences in polarizability and quadrupole moment of the adsorbates. The maximum CO₂ uptake of Na-SSZ-39 reached 10.87 mmol/cm³ (253.1 cm³ (STP)/cm³) at 10° C., and SSZ-39 displayed an uptake of 10.66 mmol/cm³ (248.2 cm³ (STP)/cm³). To further quantify the CO₂-philicity of Na-SSZ-39, the CO₂ Qₛₜ at zero coverage was determined using the Toth model to be −35.1 kJ/mol. The adsorption heat of CO₂ (−35.1 kJ/mol) in Na-SSZ39 was far larger than of CH₄ (−21.4 kJ/mol) and N₂ (−19.4 kJ/mol) as a result of the large polarizability and quadrupole moment of CO₂ (Table 1). Overall, it could be observed that a more negative CO₂ sorption enthalpy and higher CO₂ uptake were obtained for Na-SSZ-39 compared to SSZ-39. Additionally, the pronounced difference in CO₂ adsorption in the low pressure region of the isotherms suggests that Na⁺-exchange resulted in an increased affinity of the zeolite for CO₂.

TABLE 1
Fitted Toth parameters (with 95% confidence interval) of
the CO₂, CH₄, and N₂ adsorption isotherms for the three
samples (Na-SSZ-39, SSZ-39, 50 wt. % Na-SSZ-39 MMMs).

| | Na-SSZ-39 | SSZ-39 | Na-SSZ-39 MMM |
|---|---|---|---|
| Adsorbents | n (—) | | |
| CO₂ | 0.49 ± 0.01 | 0.58 ± 0.02 | 0.35 ± 0.02 |
| CH₄ | 0.52 ± 0.02 | 0.66 ± 0.02 | 0.55 ± 0.02 |
| N₂ | 0.62 ± 0.02 | 0.65 ± 0.02 | 0.55 ± 0.02 |
| Adsorbents | Kᵢ° (1/bar) | | |
| CO₂ | (9.7 ± 1.7) 10⁻⁶ | (1.2 ± 0.3) 10⁻⁵ | (3.7 ± 1.0) 10⁻⁵ |
| CH₄ | (7.2 ± 0.4) 10⁻⁵ | (8.2 ± 0.4) 10⁻⁵ | (8.4 ± 0.4) 10⁻⁵ |
| N₂ | (6.7 ± 0.3) 10⁻⁵ | (7.1 ± 0.2) 10⁻⁵ | (8.5 ± 0.5) 10⁻⁵ |
| Adsorbents | −ΔHᵢ° (kj/mol) | | |
| CO₂ | 35.1 ± 0.4 | 31.8 ± 0.6 | 32.3 ± 0.5 |
| CH₄ | 21.5 ± 0.1 | 19.7 ± 0.2 | 20.5 ± 0.1 |
| N₂ | 19.4 ± 0.1 | 17.3 ± 0.1 | 18.5 ± 0.2 |
| Adsorbents | q_{i, max}(mmol/g) | | |
| CO₂ | 7.0 ± 0.1 | 7.0 ± 0.1 | 5.0 ± 0.2 |
| CH₄ | 5.9 ± 0.2 | 5.1 ± 0.2 | 3.0 ± 0.1 |
| N₂ | 4.4 ± 0.2 | 5.0 ± 0.2 | 2.4 ± 0.1 |

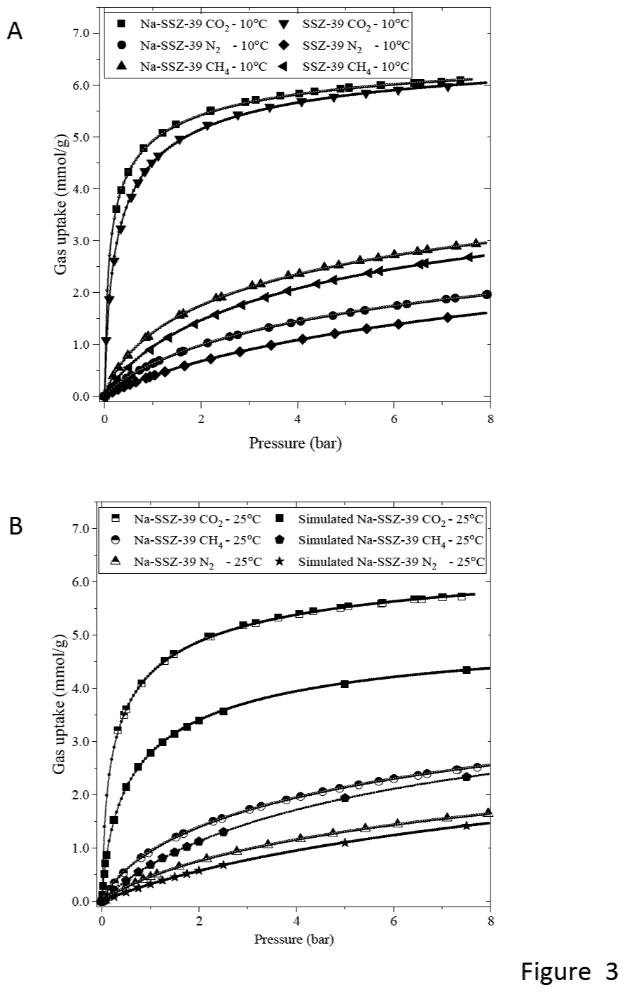

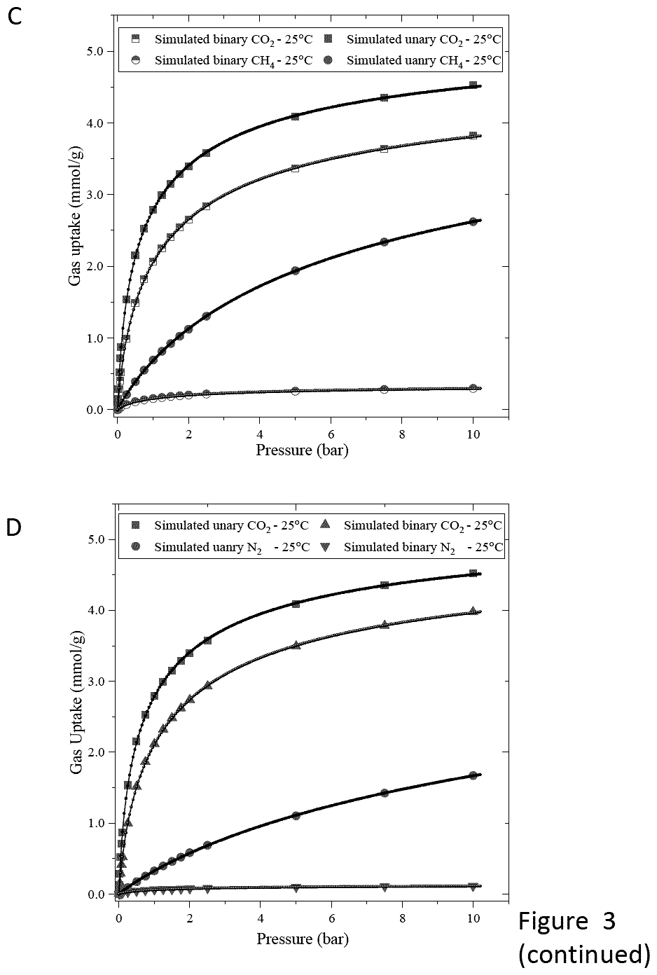

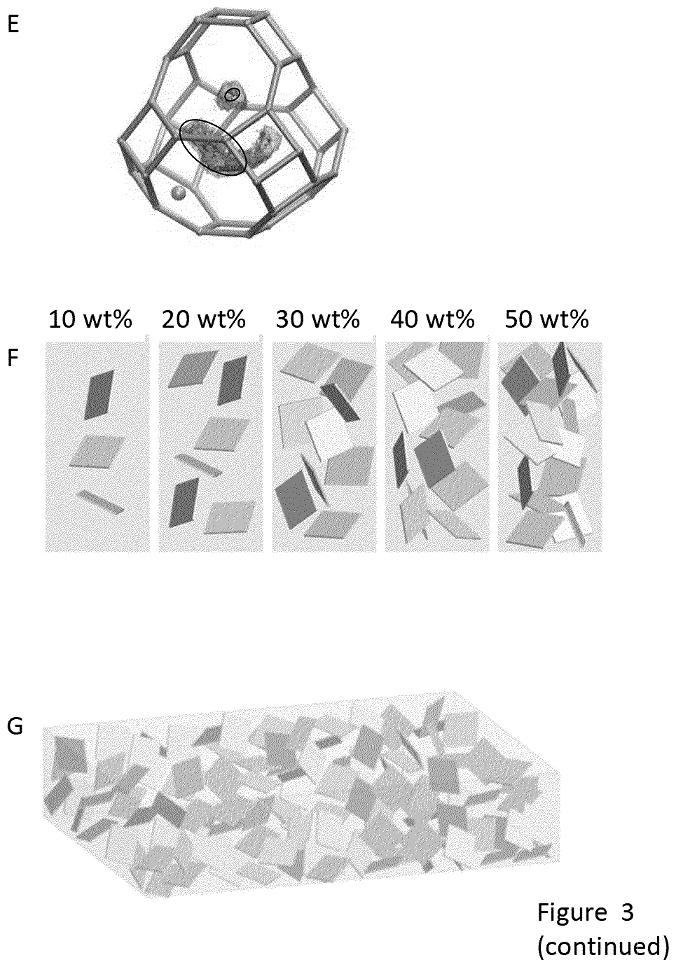

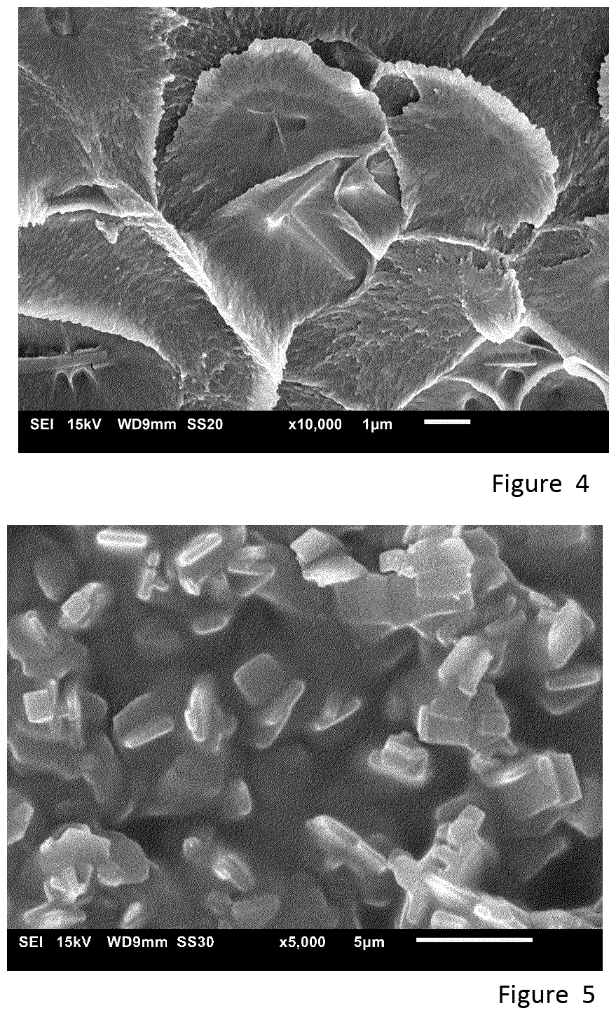

To further explain the experimental findings at a molecular level, the pure gas and mixed-gas adsorption behaviour in Na-SSZ-39 was modelled using Grand Canonical Monte Carlo (GCMC) simulations. The results from the pure gas adsorption simulations show a good qualitative resemblance with the experimental data (FIG. 3.b) and also the enthalpies of adsorption are in good agreement (at 2 bar GCMC yields −31.6 kJ/mol for CO₂, −18.5 kJ/mol for CH₄ and −15.8 kJ/mol for N₂). From the 3D density isosurfaces for CO₂ adsorption (FIG. 3.e), it follows that the CO₂ molecules preferentially interact with the Na⁺ (especially at low CO₂ pressures), while the windows of Na-SSZ-39 remain open for gas transporting. This tendency of CO₂ to approach the Na⁺ site corroborates the enhanced CO₂-philicity of the zeolite after Na⁺-exchange, improving CO₂ adsorption in Na-SSZ-39. Furthermore, CO₂/CH₄ mixed-gas sorption simulations on Na-SSZ-39 distinctly demonstrate that the competitive sorption of CO₂ at the expense of CH₄ dramatically reduces the uptake of CH₄ (FIG. 3.c). Compared to the single gas adsorption results (FIG. 3.a), the CH₄ uptake under mixed-gas conditions dropped from 1.94 mmol/g to 0.26 mmol/g at 5 bar and 25° C. (FIG. 3.c). In addition, ab initio free energy barrier calculations for the diffusion inside the zeolite further confirmed the molecular sieving behaviour of the Na-SSZ-39 zeolite. As the biggest aperture of the Na-SSZ-39 zeolite only allows for the diffusion of molecules with a diameter of 3.84 Å, which is close to the kinetic diameter of a CH₄ gas molecule (3.80 Å) and is prominently larger than the kinetic diameter of CO₂ (3.30 Å), the free energy barrier of CH₄ permeation through an 8-membered-ring in Na-SSZ-39 is about twice as high as for CO₂. As a result, the self-diffusion coefficient for CO₂ is over three orders of magnitude higher than for CH₄.

Pure gas and mixed-gas adsorption behaviour in SSZ-39 was modelled by Grand Canonical Monte Carlo (GCMC) simulations. The results from the pure gas adsorption simulation show a good fit with the experimental data (FIG. 3.b) Moreover, the 3D density plot of CO₂ adsorption (FIG. 3.e) indicates that the CO₂ adsorption mainly happened in the cage of the zeolite and the CO₂ preferentially interacted with the Na⁺ (especially in the case of low CO₂ pressure), while the window of Na-SSZ-39 remains open for gas transport. The CO₂ molecule has a tendency to approach the Na⁺ site, which explains the enhanced CO₂-philicity of the zeolite after Na⁺-exchange, improving CO₂ adsorption on Na-SSZ-39. Most importantly, the CO₂/CH₄ mixed-gas sorption simulation on Na-SSZ-39 distinctly demonstrates that competitive sorption of CO₂ at the expense of CH₄ dramatically reduces the uptake of CH₄ (FIG. 3.c). Compared to the single gas adsorption results, the CH₄ uptake under mixed-gas conditions dropped from 72.3 cm³ STP/cm³ to 7.9 cm³ STP/cm³ at 5 bar and 25° C. In addition, energy barrier calculations for diffusion inside the zeolite further confirmed molecular sieving behaviour of the Na-SSZ-39 zeolite. As the biggest aperture size of the Na-SSZ-39 zeolite is 3.84 Å, close to the kinetic diameter of CH₄ gas molecule (3.80 Å), the energy barrier of CH₄ permeation through its pores is calculated to be twice as high as for CO₂.

### Example 3 MMM Characterization

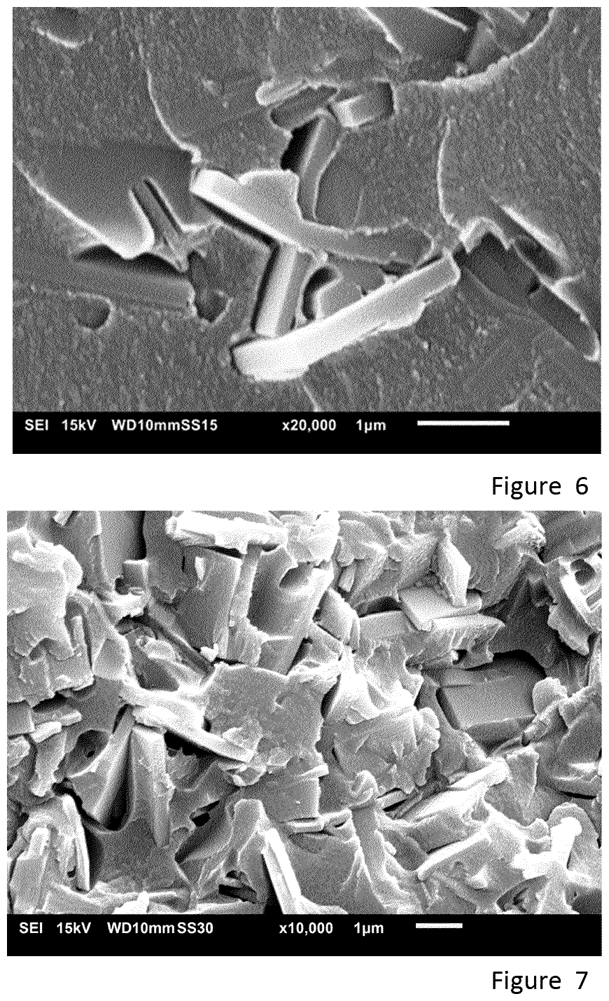

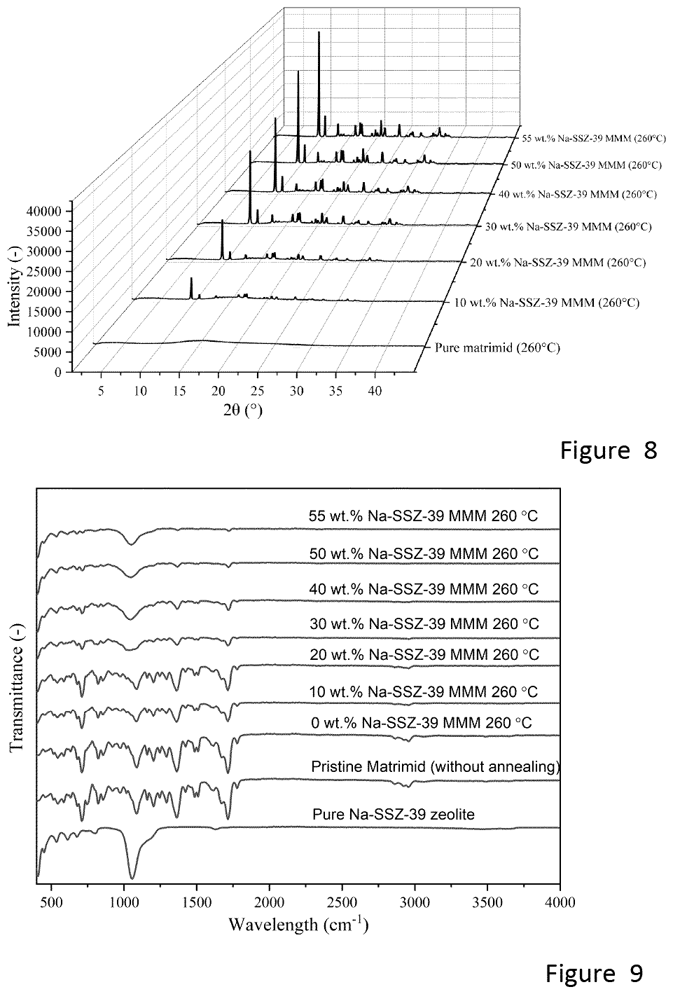

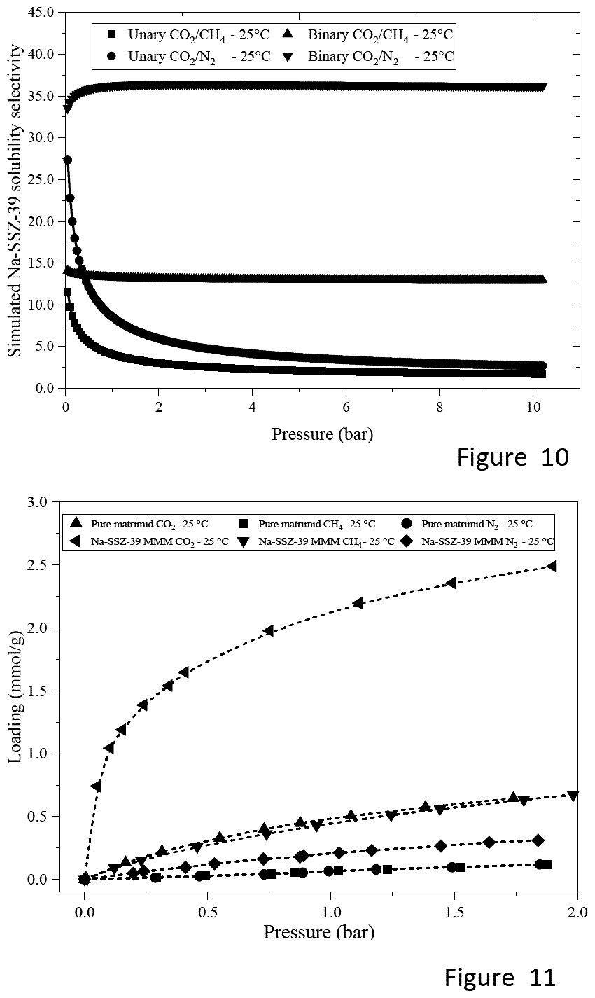

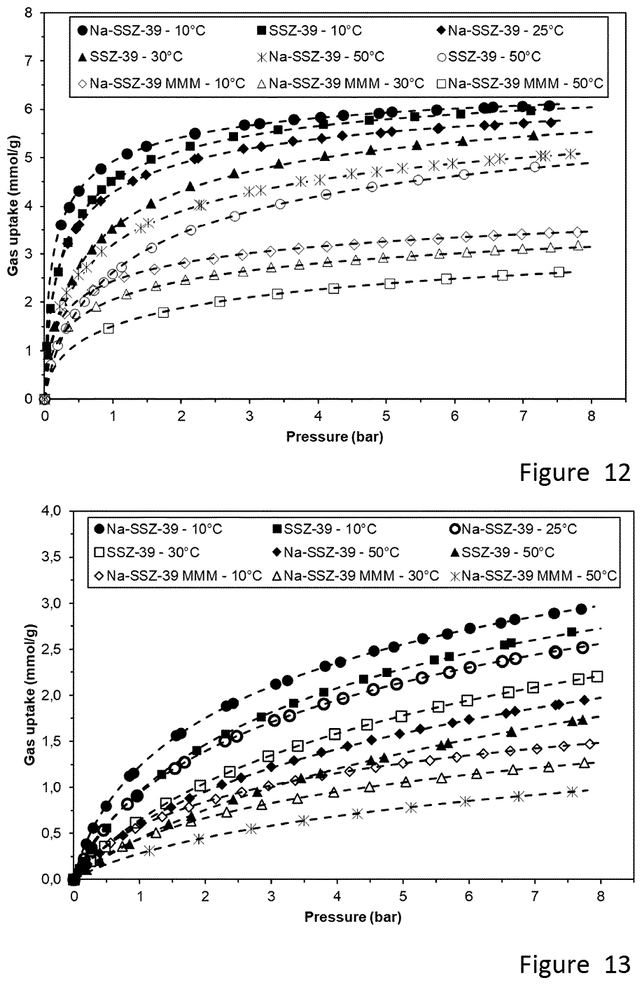

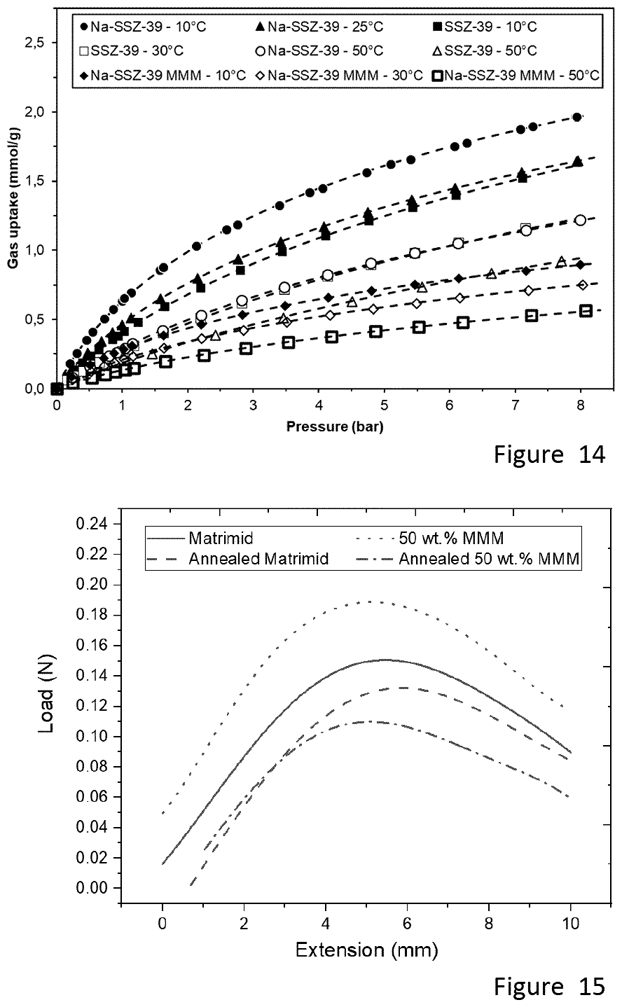

MMMs were prepared with Na-SSZ-39 reaching loadings as high as a truly exceptional 55 wt. %. XRD confirmed the preservation of the zeolite crystallinity in the MMMs after thermal treatment (FIG. 8). SEM cross-section picture of the membrane (FIG. 1.d) shows that the zeolite platelets are positioned in the polymer matrix in a random, non-aligned packing. This random distribution of the SSZ-39 zeolite platelets in the MMM stems from a subtle and carefully optimized interplay between zeolite and solvent properties during MMM synthesis. More specifically, an optimal dispersion of the zeolite in the casting solvent (i.e. chloroform) was obtained as a result of a good interaction between Na-SSZ-39 plates and the solvent, the small difference between zeolite and solvent density (1.55 g/cm³ and 1.49 g/cm³ individually) preventing particle settling, the high-aspect ratio of the platelet-shaped zeolite and the high viscosity of the final casting solution. In addition, chloroform evaporation rate during membrane formation was slowed-down in order to prevent the rigidifying polymer chains from detaching from the zeolite surface during solvent evaporation. After drying the cast film, further interfacial defect elimination was performed by an annealing protocol, which had a profound impact on the final MMM morphology. Several thermal annealing programs were tested at 180° C., 260° C., 300° C. and 350° C. Among these, annealing at 180° C. and 260° C. resulted in similar MMM CO₂ permeability but the 260° C. program induced a nearly doubled CO₂/CH₄ separation factor (for 50 wt. % Na-SSZ-39 MMMs, the separation factor increased from ˜200 to >420). Annealing at temperatures higher than 300° C. resulted in fragile and brittle, carbonized membranes with substantial voids at the zeolite-polymer interface (FIG. 6 and FIG. 7).

Full removal of the polymer by oxidative treatment at 800° C. led to a remarkable stable zeolite-only film (FIG. 1.e), clearly confirming the very high zeolite loading in a random packing, and the quasi-connected, continuous zeolite phase inside the MMM. FIG. 1.c clearly shows that membranes subjected to a 260° C. annealing treatment did not show sieve-in-a-cage morphology, which traditionally is a major issue for zeolite MMMs (FIG. 1.b). When compared to their non-annealed counterparts (FIG. 1.b), a much better zeolite-polymer adhesion after annealing can be observed.

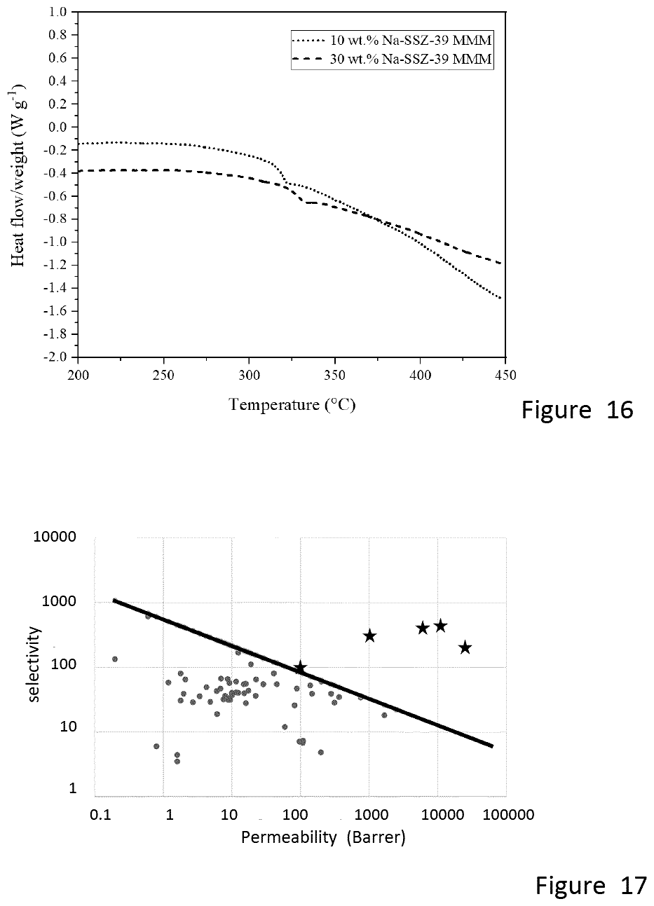

FTIR identified the typical zeolite and polymer signals at specific wavenumbers (1050 cm⁻¹ and 1090 cm⁻¹), but could not find conclusive evidence for a covalent interaction between polymer and zeolite at the interface after annealing, even at high zeolite loading (FIG. 9). To investigate the zeolite-polymer interface interaction more profoundly, confocal Raman spectroscopy was applied, which confirmed the absence of a chemical reaction between zeolite and polyimide. Although no indications for covalent bond formation were detected, the polymer chain re-arrangement and the improved wrapping around the zeolite particles induced by thermal annealing could be observed. Upon increasing the zeolite loading for 10 wt. % to 30 wt. %, the glass transition temperature (T_{g}) of thermal annealed Na-SSZ-39 MMMs steadily increased from 320° C. to 330° C., pointing towards polymer chain rigidification at the polymer-zeolite interface (FIG. 16), which indicates the wrapping of the zeolite by the polymer, thus confining the thermal motion of the polymer, and requiring more energy for polymer chain movement. CO₂, CH₄ and N₂ sorption experiments were performed on the 260° C. annealed pristine Matrimid membrane and the 50 wt. % Na-SSZ-39 MMM to quantify their respective gas uptake. A substantially higher CO₂, CH₄ and N₂ uptake was denoted for the MMM when compared to the pure Matrimid membrane (FIG. 11).

### Example 4 Membrane Gas Separation Performance

Thanks to its competitive gas adsorption behaviour, the mixed gas selectivity the SSZ-39 MMM is significantly higher than its ideal gas selectivity (Table 2).

TABLE 2
the CO₂/CH₄ and CO₂/N₂ mixed gas selectivities
(for equal mole CO₂/N₂ gas mixture, and equal
mole CO₂/CH₄ gas mixture, the partial
pressure of CO₂, CH₄, N₂ in gas mixtures
are 1 bar) and the CO₂/CH₄
and CO₂/N₂ ideal gas selectivity (the
pressure of CO₂, CH₄, N₂ feed stream
are 1 bar) of Na-SSZ-39 MMMs under 25° C.

| | CO₂/CH₄ | CO₂/N₂ | CO₂/CH₄ | CO₂/N₂ |
|---|---|---|---|---|
| | mixed gas | mixed gas | ideal gas | ideal gas |
| Membrane name | selectivity (—) | selectivity (—) | selectivity (—) | selectivity (—) |
| 10 wt. % Na-SSZ-39 | 59.1 ± 4.1 | 38.7 ± 2.1 | 37.2 ± 3.6 | 27.9 ± 3.13 |
| MMM 260° C. 24 h | | | | |
| 20 wt. % Na-SSZ-39 | 108.7 ± 15.9 | 49.8 ± 2.9 | 80.2 ± 2.1 | 33.6 ± 1.18 |
| MMM 260° C. 24 h | | | | |
| 30 wt. % Na-SSZ-39 | 313.3 ± 15.2 | 58.7 ± 3.5 | 205.7 ± 9.1 | 31.3 ± 1.99 |
| MMM 260° C. 24 h | | | | |
| 40 wt. % Na-SSZ-39 | 399.9 ± 17.3 | 59.0 ± 2.8 | 300.7 ± 14.5 | 30.1 ± 2.62 |
| MMM 260° C. 24 h | | | | |
| 50 wt. % Na-SSZ-39 | 423.5 ± 22.5 | 59.1 ± 3.2 | 335.9 ± 15.6 | 32.4 ± 2.4 |
| MMM 260° C. 24 h | | | | |
| 55 wt. % Na-SSZ-39 | 205.8 ± 37.2 | 43.2 ± 6.1 | 174.5 ± 11.2 | 17.1 ± 13.64 |
| MMM 260° C. 24 h | | | | |

For instance, for 50 wt. % Na-SSZ-39 MMM, the CO₂/CH₄ ideal gas selectivity is ˜335 at 1 bar/25° C., while the CO₂/CH₄ mixed gas (CO₂/CH₄=50 vol. %/50 vol. %) selectivity reached ˜423 at 2 bar/25° C. (both CO₂ and CH₄ partial pressure are equal to 1 bar). Likewise, the CO₂/N₂ ideal gas selectivity at 1 bar/25° C. is ˜32, while its mixed gas selectivity at 2 bar/25° C. increased to ˜60. So clearly, once the stronger adsorbing CO₂ occupies the adsorption sites, the zeolite channels become partly inaccessible for other gases, and permeation of CH₄ and N₂ is prevented. Based on the MMM sorption and the pure gas permeation experiments, gas solubility and gas diffusivity values were calculated for the pristine Matrimid membrane and the 50 wt. % Na-SSZ-39 MMM (Table 3).

TABLE 3
Unary CO₂, CH₄, N₂ gas uptake (cm3 STP/cm3), ideal permeability P (Barrer), solubility
S (10⁺ cm3 (STP)/cm³ cmHg), diffusivity D (10⁸ cm2/s), and the comparison
of these values of 50 wt. % Na-SSZ-39 MMM and pristine Matrimid membrane (both
membranes underwent 260° C. thermal annealing program) under 25° C., 1 bar.

| Gas | Uptake (cm³ STP/cm³) | P (barrer) | S (10⁻² cm³(STP)/(cm³*cmHg)) | D (10⁻⁸ cm²/s) |
|---|---|---|---|---|
| | Pristine Matrimid membrane | | | |
| CO₂ | 15.15 | 8.19 ± 1.83 | 20.20 | 0.41 |
| CH₄ | 2.04 | 0.181 ± 0.088 | 2.72 | 0.09 |
| N₂ | 2.05 | 0.511 ± 0.147 | 2.74 | 0.19 |
| | 50 wt. % Na-SSZ-39 MMM | | | |
| CO₂ | 70.09 | 8328.5 ± 476.5 | 93.44 | 89.13 |
| CH₄ | 15.38 | 24.7 ± 1.4 | 20.51 | 1.21 |
| N₂ | 6.96 | 256.89 ± 67.3 | 9.29 | 27.67 |

| | Uptake_{MMM}/Uptake_{matrimid} | P_{MMM}/P_{matrimid} | S_{MMM}/S_{matrimid} | D_{MMM}/D_{matrimid} |
|---|---|---|---|---|
| CO₂ | 4.63 | 1016.91 | 4.63 | 219.78 |
| CH₄ | 7.53 | 104.61 | 7.53 | 13.89 |
| N₂ | 3.39 | 503.70 | 3.39 | 148.27 |

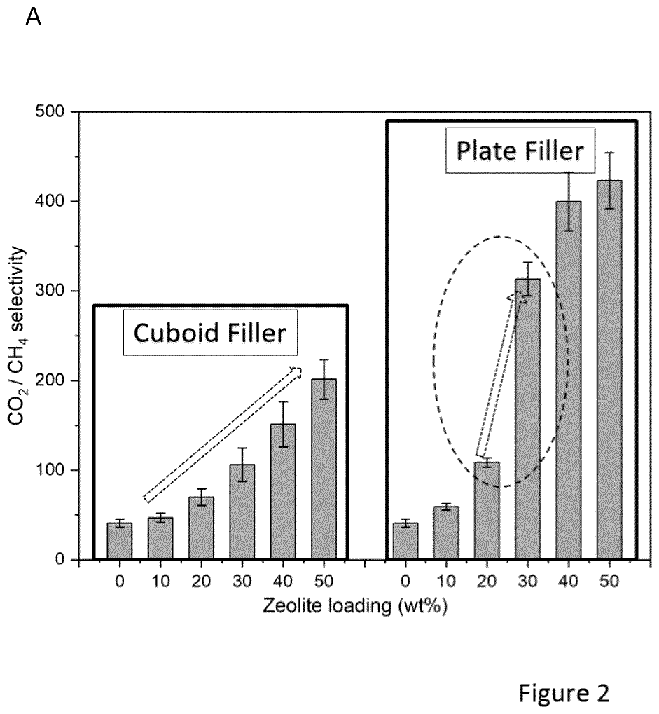

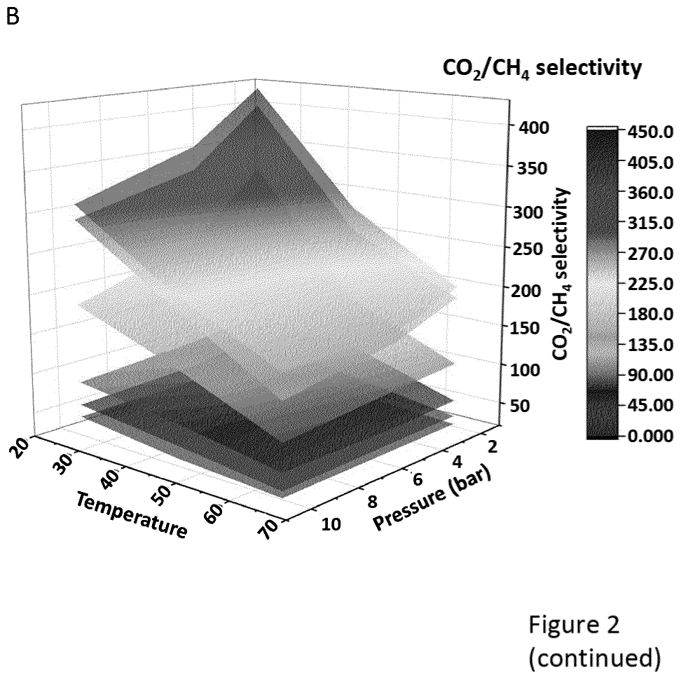

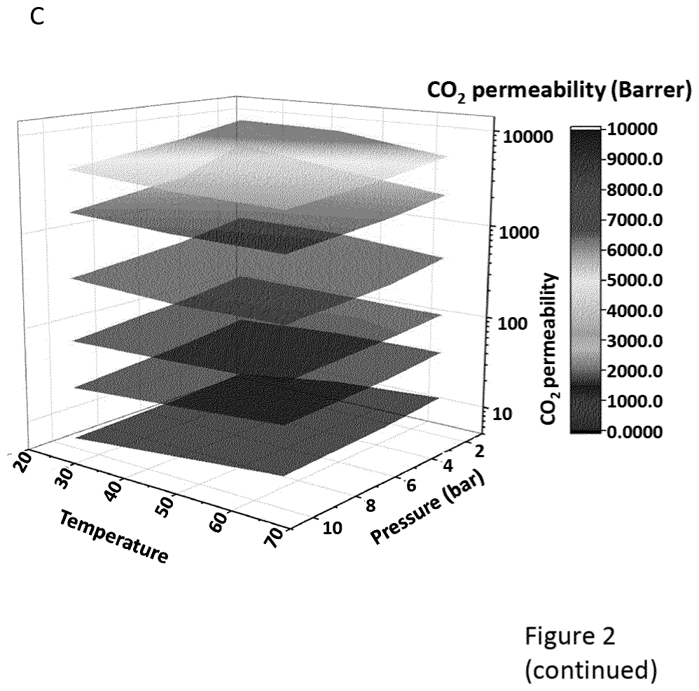

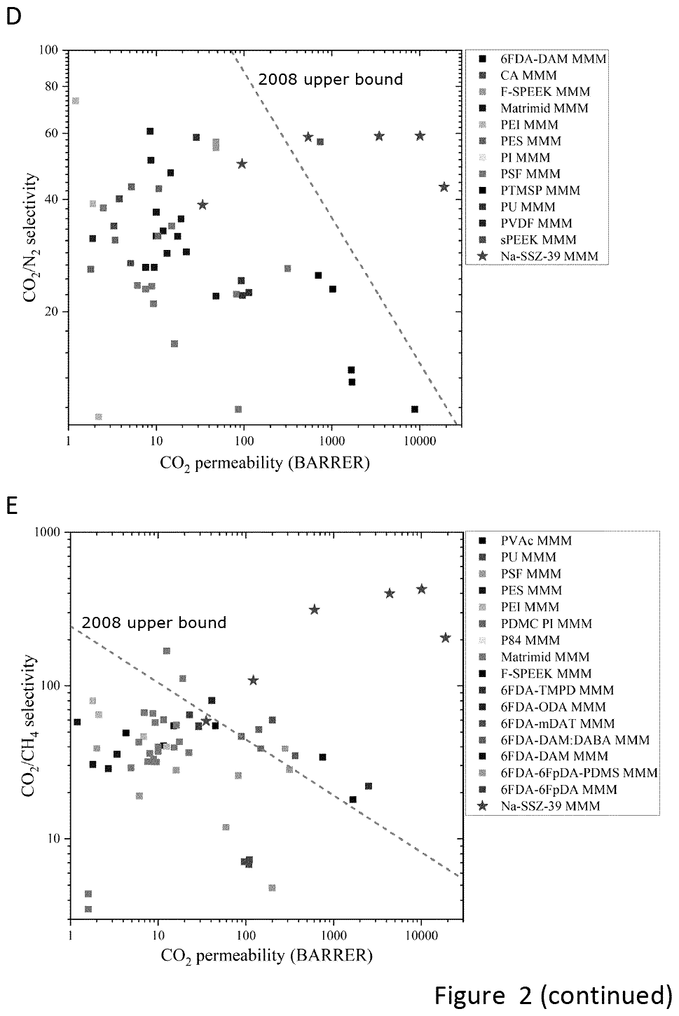

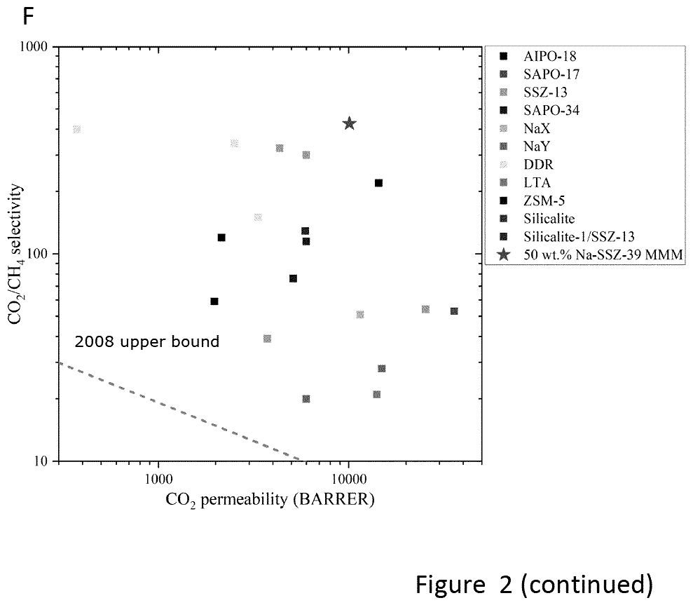

With respect to the unfilled polymer membrane, the MMM displayed a 4.6 times higher CO₂ solubility and the CH₄ and N₂ solubility of the Na-SSZ-39 MMM increased by a factor of 7.5 and 3.4, respectively. A 220-fold increase in CO₂ diffusivity was denoted for the Na-SSZ-39 MMM compared to unfilled Matrimid membrane, while CH₄ and N₂ diffusivity increased by a factor of 14 and 148, respectively. An enhancement of the MMM CO₂/CH₄ diffusivity selectivity (+1104%) thus appears to be at the base of the strong improvement of MMM gas separation capability. This can be explained by the sharp size sieving effect of Na-SSZ-39 for CH₄ as the zeolite pore size (3.84 Å) is almost equal to the kinetic diameter of CH₄ (3.80 Å). The increase in diffusivity selectivity for CO₂/N₂ is far less pronounced as N₂ possesses a smaller kinetic diameter (3.64 Å), which is in line with the observed CO₂/N₂ permeation behaviour of the SSZ-39 MMMs. Mixed-gas CO₂/CH₄ and CO₂/N₂ separation performances are presented in FIG. 2.D and FIG. 2.E. For CO₂/CH₄, a continuous increase in separation factor is observed when realising higher loadings of Na-SSZ-39. Whereas the unfilled Matrimid membrane denotes a CO₂/CH₄ separation factor of ˜45 and CO₂ permeability ˜8 Barrer, the best MMM performance was obtained with 50 wt. % Na-SSZ-39 loading, which obtained a stunning separation factor of ˜423 at 2 bar/25° C. Simultaneously, a CO₂ permeability of ˜8280 Barrer could be obtained (a ˜1037-fold increase). Similar results were obtained for the MMM CO₂/N₂ separation performance. Here, the 50 wt. % MMM combined a CO₂ permeability of ˜8300 Barrer with a CO₂/N₂ separation factor of ˜60. FIG. 2.b and FIG. 2.c show the temperature and pressure dependency of the CO₂/CH₄ separation factor and CO₂ permeability of Na-SSZ-39 MMMs with different zeolite loadings. With increasing temperature, the CO₂ adsorption in the zeolite is decreased (FIG. 12), resulting in a CO₂ permeability decrease, while CH₄ permeability increases slightly, resulting in a decreased CO₂/CH₄ selectivity. Similar behaviour was observed with rising feed pressure: both CO₂ permeability and CO₂/CH₄ selectivity decreased. This can be explained by the high CO₂-philicity of the Na-SSZ-39 zeolite filler, which is already saturated with CO₂ molecules at low feed pressure (FIG. 12). Further increasing the pressure thus has far less impact on CH₄ permeability compared to the CO₂ permeability. For the same reason, when exposing the membranes to feeds with lowered CO₂ partial pressures, the Na-SSZ-39 MMMs exhibit enhanced performance compared to testing under equal-mole gas mixtures. For instance, the 50 wt. % Na-SSZ-39 MMM gave a CO₂ permeability of over 10000 Barrer, and a CO₂/CH₄ separation factor of over 460 for a 20 vol. % CO_{2/80} vol. % CH₄ feed.

When depicted on selectivity-permeability trade-off plots, the Na-SSZ-39 MMMs already surpass the trade-off line for CO₂/CH₄ from only 20 wt. % zeolite loading onward (FIG. 2.E) and from 30 wt. % zeolite loading for CO₂/N₂ (FIG. 2.D). Ultimately, they realize an unprecedented jump towards the upper right corner of the Robeson plot for MMMs, ending up even beyond the performance area that is dominated by pure zeolite membranes (FIG. 2.F). Outperforming the pure zeolite membranes can be related to the outstanding property of the Na-SSZ-39 filler, and the unique morphology of the ultra-high zeolite loading membranes. Moreover, compared to the pure zeolite membranes, the Na-SSZ-39 MMMs additionally keep their flexibility because of the presence of the polymer matrix, thus indicating better upscaling potential. From an application point of view, the exceptional combination of the very high fluxes and selectivities can allow significant reductions in both operational and capital costs, as simplified and more energy-efficient operation scheme with less recycling and milder (re-) compression stages can be applied, in combination with reduced membrane areas.

The exceptional and outstanding gas separation performance of the Na-SSZ-39 MMMs can be explained by a combination of factors. By synthesizing full Na⁺-exchanged SSZ-39 zeolites, a more CO₂-phillic adsorption environment was created, resulting in higher CO₂ uptake and stronger CO₂ affinity. GCMC modelling and calculation of the gas diffusivity selectivities of the membranes revealed a very accurate CO₂/CH₄ size sieving effect in combination with strong competitive sorption of CO₂ at the expense of CH₄ and N₂. This effect is clearly confirmed by the mixed-gas GCMC simulations (FIG. 3.C and FIG. 3.D). In other words, in mixed-gas conditions, CH₄ was prevented from entering the zeolite cage by a combination of geometric restrictions of the zeolite pore and a competitive advantage in adsorption on the zeolite for CO₂, further limiting access of CH₄. The notable difference in separation factor for CO₂/CH₄ and CO₂/N₂ (˜423 and ˜60 respectively, for 50 wt. % Na-SSZ-39 MMM at 2 bar, 25° C.) is an almost direct result of the smaller kinetic diameter of N₂ compared to CH₄ and hence confirms the central role of the size sieving mechanism.

Secondly, the sudden jump in CO₂/CH₄ separation factor at 20-30 wt. % loading suggests a percolation effect, i.e. from this loading onward, gas permeation through the membrane is predominantly dictated by the zeolite phase. The reason for this shift in phase dominance should be sought in the practical ability to incorporate unusually high loadings of zeolite in the polymer matrix. This creates a unique membrane morphology, which consists of a quasi-connected, continuous zeolite phase within the polymer matrix starting at 20-30 wt. % zeolite loading and allows for percolation of the gas molecules with minimal influence of the polymer phase. The SEM top (FIG. 1.E) and bottom (FIG. 1.F) view of the membranes with different zeolite loading show that the zeolite platelets pile up from the bottom and appear at the top of membrane when zeolite loading reach 30 wt. %.

In this context, the non-aligned, random Na-SSZ-39 platelet distribution in the MMM polymeric matrix (as a result of the zeolite shape and optimized MMM synthesis) is identified as a key driver and prerequisite for the membrane's extraordinary performance. The random zeolite packing ensures an overall connectivity between the zeolite particles dictating the permeation pathway of the gas molecules. This was confirmed by comparing the CO₂/CH₄ separation performance of MMMs containing platelet-shaped Na-SSZ-39 with MMMs carrying cuboid Na-SSZ-39. As can be seen in FIG. 2.A, the sudden increment in CO₂/CH₄ selectivity was only observed for the platelet-shaped zeolites and not for the cuboid Na-SSZ-39. Furthermore, the platelet-shaped Na-SSZ39 MMMs show a far better CO₂/CH₄ selectivity and CO₂ permeability compared to the cuboid Na-SSZ-39 MMMs with the same zeolite loading.

Thirdly, as the overall gas transport through the MMM is a net result of the properties of both zeolite and polymer, as well as of their mutual interactions, it is crucial to obtain a defect-free interface between Matrimid and Na-SSZ-39. The thermal annealing protocol minimizes the occurrence of unselective voids at the zeolite polymer interface, allowing for ultrahigh zeolite loadings of over 50 wt. % without chemical modification of zeolite or polymer, nor use of additives. This was visualized by SEM cross-section images.

### Example 5. 3-Points Bending Test

A 3-points bending test was performed on an Instron 5943 for flexural modulus measurement. The support span was 20 mm, and the maximum extension distance was set as 10 mm. Four samples has been tested: pure Matrimid membrane (without thermal treatment); 260° C. thermal annealed pure Matrimid membrane; 50 wt. % zeolite MMM (without thermal treatment); 260° C. thermal annealed 50 wt. % zeolite MMM. All of the membrane coupons were prepared as 60 mm×20 mm size (thickness 80-100 μm), and each membrane coupon has been tested 4 times with the maximum loading extension. The flexural modulus was calculated based on the equation 1:

$${E}_{flex} = \frac{{L}^{3} F}{4 w {h}^{3} d} \qquad ( 1 )$$

w: the width of the membrane coupon;
h: the thickness of the membrane coupon;
L: the distance between the support span;
d: the extension of the load;
F: the load force applied at the middle of the beam.

The flexural modulus of 4 membrane samples is listed in Table 1. All of the membrane coupons did not break during the test, and all of the membrane samples could return to their original shape after removing the loading. As the flexural modulus shows, both the zeolite loading and thermal annealing treatment reduced the flexibility of the membrane coupons, which increased their flexural modulus.

TABLE 4
The flexural modulus of the membrane coupons.

| Membrane name | Flexural Modulus (GPa) |
|---|---|
| Matrimid | 3.193 ± 0.018 |
| Annealed Matrimid | 3.969 ± 0.025 |
| 50 wt. % MMM | 5.86 ± 0.226 |
| Annealed 50 wt. % MMM | 6.911 ± 0.045 |

### Example 6. Further Embodiments of Mixed Matrix Membranes

3 further membranes were prepared
Na-CHA-10 zeolite with polyimide polymer
Na-FAU-2 zeolite with polyimide polymer
Na-FAU-2 zeolite with polysulfone (Ultrason® 52010) polymer

Herein Na-CHA-10 is a cubic-shaped, 8-membered-rings (8MR), CHA-type framework zeolite filler with Na+ counterions and Si/Al molar ratio is ˜10.

Herein FAU is an octahedral-shaped, 12-membered-rings (12MR), FAU-type framework zeolite filler with Na+ counterions and Si/Al molar ratio is ˜2.

These additional membranes were prepared using the same solvents and conditions as disclosed in example 1, with the exception of the last heating step.

Na-CHA-10/Matrimid MMM and Na-FAU-2/Matrimid MMM were subsequently heated for 24 hours under 260° C.

Na-FAU-2/polysulfone MMM was subsequently heated for 12 hours at 50° C.

FIG. 18 shows the permeability and selectivity of these membranes compared with prior art membranes, indicating similar of superior properties compared with the prior art.

1. A mixed matrix membrane (MMM) for the filtration and separation of gasses, obtainable by the method according to any one of claims 14 to 27, wherein the membrane comprises a glassy-polymer matrix with at least 20% w/w zeolite, and wherein the zeolite polymer matrix lacks interfacial voids or wherein voids are less than 20 nm measured at its longest dimension.

2. The MMM according to claim 1, wherein the membrane comprises a glassy-polymer matrix with at least 30, 40, or 50% w/w zeolite.

3. The MMM according to claim 1 or 2, wherein the zeolite is a platelet, cubic, cuboid, spherical or octahedron shaped zeolite.

4. The MMM according to any one of claims 1 to 3, wherein the zeolite is platelet shaped and has a concentration in the membrane of least 20% w/w, of least 30% w/w, of least 40% w/w, or of least 50% w/w.

5. The MMM according to any one of claims 1 to 4, wherein the membrane has a concentration of at least 40% w/w zeolite, and has a CO₂ permeability of at least 4000 Barrer.

6. The MMM according to any one of claims 1 to 5, wherein the membrane has a concentration of at least 20% w/w zeolite/polymer, and has a CO₂/CH₄ selectivity >100.

7. The MMM according to any one of claims 1 to 5, wherein the membrane has a concentration of at least 40% w/w zeolite, and has a CO₂/CH₄ selectivity >400.

8. The MMM according to any one of claims 1 to 7, wherein the zeolite is platelet shaped.

9. The MMM according to any one of claims 1 to 8, wherein the zeolite is an 8 or 12 membered ring.

10. The MMM according to any one of claims 1 to 9, wherein the zeolite is of the AEI type.

11. The MMM according to any one of claims 1 to 10, wherein the membrane is flexible and has a flexural modulus of between 2 up to 9 Gpa.

12. The MMM according to any one of claims 1 to 11, wherein the membrane is flexible and has a flexural modulus of between 3.5 up to 9 Mpa.

13. The MMM according to any one of claims 1 to 12, wherein the polymer is a polyimide.

14. A method for preparing a mixed matrix membrane comprising the step of:
a) preparing a glassy polymer and zeolite mixture in a solvent, wherein the solvent comprises at least 5% w/v polymer, and comprises at least 20, 30, 40 or 50% w/w zeolite,
b) casting the mixture obtained in step a),
c) drying the cast mixture obtained in step b) to obtain a membrane, wherein the drying is performed at a rate whereby between 85 and 95 wt. % of the solvent is removed over a period of between 15 minutes and 24 hours,
d) heating the dried membrane obtained in step c) at a temperature below the glass transition temperature of the polymer, wherein the heating is maintained for a period of between 5 min and 24 hours and/or is performed at a temperature of between 3° and 300° C., with the proviso that the temperature is below the transition temperature of the polymer.

15. The method according to claim 14, wherein the solution of polymer and the dispersion of zeolite are prepared separately and subsequently mixed.

16. The method according to claim 14 or 15, wherein the drying in step c) is performed at a rate whereby between 85 and 95 wt. % of the solvent is removed over a period of between 5 minutes and 24 hours.

17. The method according to claim 14 or 15, wherein the drying in step c) is performed at a rate whereby between 85 and 95 wt. % of the solvent is removed over a period of between 3 and 24 hours.

18. The method according to any one of claims 14 to 17, wherein in step d, the membrane is heated as a temperature between 30° C. and the glass transition temperature of the polymer.

19. The method according to any one of claims 14 to 17, wherein in step d, the membrane is heated as a temperature of between 120 or 150° C. and the glass transition temperature of the polymer.

20. The method according to any one of claims 14 to 19, wherein the heating in step d) is maintained for a period between 4 hours and 24 hours.

21. The method according to any one of claims 14 to 19, wherein the heating in step d) is maintained for a period between 8 hours and 24 hours.

22. The method according to any one of claims 14 to 19, wherein the heating in step d) is maintained for a period between 8 hours and 24 hours and/or wherein step d) is performed at a temperature of between 150° C. and 300° C.

23. The method according to any one of claims 14 to 22, followed by a step wherein the absence of voids is determined.

24. The method according to claim 23, wherein the absence of voids is determined by microscopy.

25. The method according to claim 23, wherein the absence of voids is determined by measuring the flow rate of a gas over the membrane.

26. The method according to any one of claims 14 to 25, wherein the zeolite is platelet shaped.

27. The method according to any one of claims 14 to 26, wherein the zeolite is of the AEI type.

28. The method according to any one of claims 14 to 27, wherein the polymer is polyimide.
